(19) United States
(12) Patent Application Publication
(10) Pub. No.: US 2005/0108484 A1
(43) Pub. Date: May 19, 2005

(54) System and method for highspeed and bulk backup

(76) Inventor: Sung Won Park, Kyounggi-do (KR)

Correspondence Address: FISH & RICHARDSON PC, 225 FRANKLIN ST, BOSTON, MA, 02110, US

(21) Appl. No.: 10/500,666

(22) PCT Filed: Mar. 13, 2002
(86) PCT No.: PCT/KR02/00435

(30) Foreign Application Priority Data
Jan. 4, 2002 (KR) 2002/0000477

(51) Int. Cl. G06F 12/16

(52) U.S. Cl. 711/162

(57) ABSTRACT

The present invention relates to a system and method for high-speed and bulk backup, and more particularly to a system and method for high-speed and bulk backup, wherein the data dispersed into a volume unit is set up, again divided into numerous units such as blocks to perform multi-processes that those units are compressed and transferred sequentially to different storage devices by a plurality of multiple threads, consequently, the time required for backup and recovery as well as the time required for data compression can be reduced as several flows are running simultaneously within a process, in a backup system for protecting the data stored on the storage unit to store the data within a system from disasters, defects, accidents, etc. According to the invention, since a bulk data can be transferred much faster, compared to conventional methods wherein a volume is compressed and transferred by a thread in charge, it has an effect that the time required for backup and recovery can be reduced substantially as well as the compression rate can be increased on a large scale.

### TECHNICAL FIELD

The present invention relates to a system and method for high-speed and bulk backup, and more particularly to a system and method for high-speed and bulk backup, wherein the data dispersed into a volume unit is set up and divided into numerous units such as blocks to perform multi-processes that a plurality of threads are compressed sequentially and transferred to different storage devices, consequently, the time required for backup as well as the time required for data compression can be reduced as several flows are rimming simultaneously within a process, in a backup system for protecting the data stored on the storage device to store the data within a system from viruses, accidents, etc.

### BACKGROUND ART

According to the U.S. Institute of Emergency Planning, it was reported that the average loss for industries due to the data losses caused by computer faults already had reached one hundred thousand dollars per hour as of 1994, and stressed that data backup and its recovery would be the most important matter directly related to national competitiveness and security, even for government offices dealing with national data resources under the slogan of electronic government, as well as for business enterprises, regardless of its financial loss.

Recently, while all the industrial sectors being converted into the Internet environment, the amount of corporate data as well as personal data continues on the rise in geometric progression, accordingly construction or addition of an advanced enterprise computing environment based upon storages, such as data warehouse, enterprise resource planning, customer relationship management, knowledge management, etc. is growing on a large scale.

In terms of the storages being installed in various types of businesses, as stated above, it would require the extension for hundreds of megabytes or dozens of gigabytes in a day, therefore the task of maintaining and protecting bulky data from a natural disaster such as flood, fire, etc. or an unexpected calamity such as terror, fault, accident, etc. becomes an essential part of business enterprises for their existence with the stream of the times.

Varying circumstances, leading companies such as Veritas, IBM, CA, Legato, etc. have developed backup solutions like NetBackup, Tivoli, BrightStor, NetWorker, etc. and provided software that the data stored in backup object disks, main storage devices connected with the main system, can be backed up onto backup disks like a tape libraries or disk libraries. There are various types of backup solutions, such as direct backup, network backup, SAN backup, server-less backup, etc.

The types of backup solutions are summarized as follows. As illustrated in FIG. 1, direct backup is a backup solution that is configured to have tape drives connected independently with each server, accordingly it has the advantages of no loads on the network, etc. and speedy backup, however, it costs much in purchasing tape drives and its backup software, and also it has difficulty in centralized management. As a result, it can be useful only if the number of servers for backup is limited less than three and the capacity of each server less than 100 gigabytes.

As illustrated in FIG. 2, network backup is a backup solution that is configured to have a backup server by assigning one among many servers connected on a network and the backup server provides a backup for other servers via the network. As a merit, a centralized management can be achieved easily and the cost for purchasing backup equipment and software can be low, however, it has a problem such as an excessive load on the network, transferring high volume data via the same network during the process of a backup.

SAN backup, not shown, is a backup solution that is configured to have servers, storages and backup devices connected via a fiber channel requires a lot of investment but has the highest backup performance. Besides, server-less backup is a backup solution with a good performance using a method of dispersing the function of a backup server by reducing the rate of CPU usage.

However, conventional backup solutions stated above still have a problem, wherein the more backup files or data they have within a main storage device, the lower backup speed they get.

Therefore, it is an important issue to reduce the time required for backup and recovery to the lowest degree. Besides, the compression part for storing a lot of data more efficiently within the limited capacity of tape libraries or disk libraries whereon the backup data to be stored is another key issue.

### DISCLOSURE OF THE INVENTION

The present invention is provided to solve the problems as stated above, and it is an object of the invention to provide a backup and recovery at a higher speed during the process of backup and recovery for the system data.

It is another object of the invention to improve the efficiency of a storage device using compression, backup and recovery for a lot more data within the limited capacity of storage devices.

In order to accomplish these objects, a system for high-speed and bulk backup includes a backup object disk whereon a backup object data to be stored; a backup disk whereon the backup object data to be compressed and stored; and a backup means, wherein a volume of backup object data stored in the backup object disk is divided into a predetermined size of unit data, a plurality of threads running several flows within a process are generated and thereby the divided unit data are sequentially compressed and stored onto the backup disk.

Preferably, the system of high-speed and bulk backup further includes an input/output unit, wherein the command including backup operating commands is supplied, and the result from the predetermined command is output; and a central processing unit, wherein the backup operating command supplied through the input/output unit is processed, thereby a backup can be implemented with a backup means.

Moreover, the backup means includes a backup master module, wherein a backup operating command supplied through the input/output unit and central processing unit is received and transmitted to a backup manager module; a backup manager module, wherein the backup operating command required for operating a backup is received from the backup master module and the backup reservation information for each volume is managed, a backup status and backup history information for each volume is collected and managed, and the backup command for a disk volume according to a backup schedule is transmitted to a backup agent module; and a backup agent module, wherein the backup commands are supplied from the backup manager module and the volume of data on a backup object disk is divided into a predetermined size of unit data, a plurality of threads running several flows within a process are generated, and thereby the divided unit data can be sequentially compressed and stored onto the backup disk.

Preferably, another embodiment of the invention comprised of a backup master server, including a backup master module; and a plurality of backup manager servers including a backup manager module and a backup agent module, having a backup object disk and a backup disk, wherein when a command including backup operating commands is received by the backup master server and transmitted to the backup manager server, the backup reservation information per each volume is managed, a backup status and backup history information per each volume is collected and managed by the backup manager module, and the backup command for a disk volume according to a backup schedule is transmitted to a backup agent module, then according to the backup command supplied from the backup manager module, a volume of data on the backup object disk is divided into a predetermined size of unit data, a plurality of threads running several flows within a process are generated, and the divided unit data are sequentially compressed and stored onto the backup disk by the backup agent module.

Moreover, still another embodiment of the invention comprised of a backup master server including a backup master module; a plurality of backup manager servers including the backup manager module, having backup object disks; and a backup agent server including the backup agent module, having backup disks, wherein when a command including the backup operating commands is received by the backup master server and transmitted to the backup manager server, the backup reservation information per each volume is managed by the backup manager module within the backup manager server, a volume of data is divided into a predetermined size of unit data, read and transmitted to the backup agent server, a backup status and backup history information per each volume is collected and managed according to the backup progress at the side of backup agent server, and the backup command for a disk volume according to a backup schedule is transmitted to a backup agent server by the backup object disk, then according to the backup command supplied from the backup manager module, a plurality of threads are generated, a predetermined size of unit data is received in order, a plurality of threads generated are sequentially compressed and stored onto the backup disk by the backup agent module within the backup agent server.

Preferably also, during the recovery process of data stored in a backup disk, the unit data divided and compressed will be restored in reverse order with a thread technique, the most suitable size of data will be “block size (4096×N)×number of blocks (M)≅20˜25 Mbytes” in a predetermined unit size while implementing a backup and recovery.

In case the backup object data stored in a backup object disk of the backup manager server is more than one hundred thousand, volume backup, where a backup is provided by dividing the whole volume of a backup object data into the unit data through accessing to a raw device regardless of the type of file, is faster, however, in case the backup object data is less than one hundred thousand, file backup, where each file is divided into the unit data, sequentially compressed using a thread technique and stored in a backup disk of the backup server, is faster. So, it is preferable that either file backup or volume backup can be selectively implemented in the backup manager server according to the number of files of the backup object data.

A method of high-speed and bulk backup according to the invention comprises the steps of receiving the compression object disk information and the directory information to be stored; driving a plurality of compression threads; dividing and reading block index values supplied from the compression object disk on a plurality of driven compression threads; reading each data block belong to the block index read for each compression thread; compressing simultaneously for each data block read on a plurality of compression threads; storing the data blocks compressed to a storage directory for a plurality of compression threads; judging whether there exist more data blocks to be compressed, increasing the block index if there exist more data blocks to be compressed, then interrupting to read the data block; finishing a plurality of threads if there exist no data blocks to be compressed; and completing a backup by ensuring that compression of all data blocks is completed.

Preferably, the input at the level of driving the compression threads is a block index, and the input for the data compression means while the compression being in progress is a compression object data block, and the output is a data block compressed.

Preferably also, backup data can be restored in reverse order of the backup method aforementioned, and the data to be compressed can be sequentially implemented by dividing the data on a volume into a unit data, or sequentially processed for a plurality of files by threads.

### BRIEF DESCRIPTION OF DRAWINGS

FIG. 1 is a block diagram showing conventional direct backup.

FIG. 2 is a block diagram showing conventional network backup.

FIG. 3 is a block diagram showing a preferred embodiment of backup system according to the present invention.

FIG. 4 is a block diagram showing another preferred embodiment of backup system according to the present invention.

FIG. 5 is a block diagram showing still another preferred embodiment of backup system according to the present invention.

FIG. 6 is an exemplary diagram showing a method dividing a volume in detail according to the present invention.

FIG. 7 is a flowchart showing a method of backup according to the present invention.

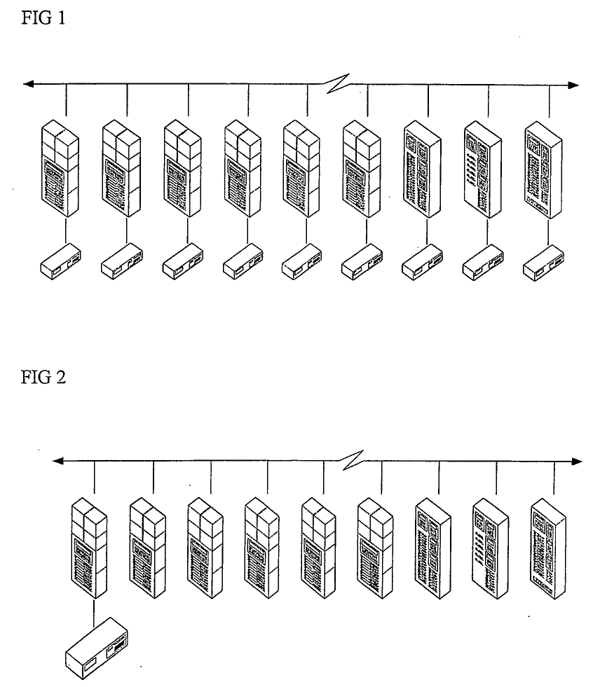

### BEST MODE FOR CARRYING OUT THE INVENTION

Hereinafter, the preferred embodiments of the present invention will be described in detail with the accompanying diagrams.

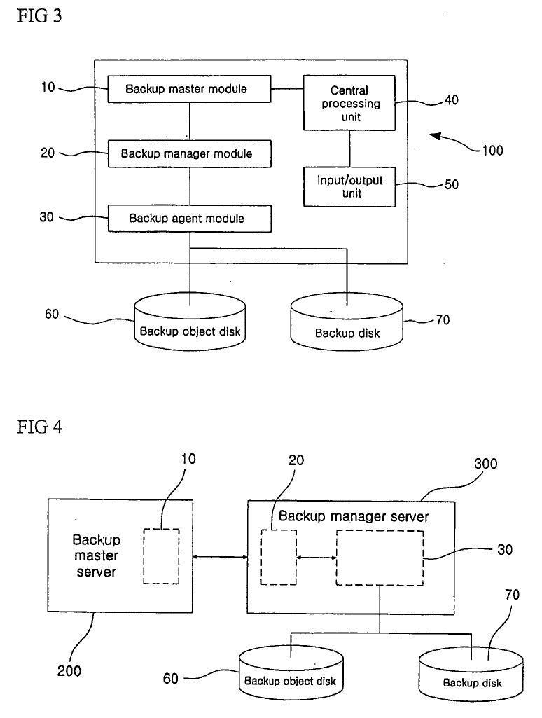

As illustrated in FIG. 3, a block diagram showing a system of high-speed and bulk backup according to the present invention, the system of high-speed and bulk backup 100 has a form of implementation integrated into a computer system, and here the elements not directly related to the invention within a computer system are not shown.

The system of high-speed and bulk backup 100, shown in FIG. 3, it comprises the modules such as backup master module 10, backup manager module 20 and backup agent module 30, as the units performing one or more specific functions, an input/output unit 50 wherein a command including backup operating commands is received from outside, and a central processing unit 40 to control a backup object disk 60 whereon the data for backup is stored, a backup disk 70 whereon the backup object data stored in a backup object disk is compressed and stored, and the modules 10, 20, 30 through the commands supplied through the input/output unit 50.

In concrete terms, the backup master module I0 as an element performing the function to manage an overall backup system, manages backup reservation information for each volume and provides backup commands to the backup manager modules 20 according to a backup schedule.

Here, backup reservation information means the data such as from which disk, to which disk, on which time, for which period, etc. that have been set Up by a backup manager according to an automatic backup, and therefore the backup master module 10 will be operating automatically according to a reserved backup schedule in order to proceed a backup on the backup manager module 20 and the backup agent module 30.

On the other hand, when there is a plurality of backup manager modules 20, it is preferable for a backup master module 10 to manage a backup by bundling multiple backup manager modules 20 in a group.

The backup manager module 20 receives backup operating commands required for backup management from the backup master module I0 and transmit them to the backup agent module 30, and moreover to collect the backup status and history for each volume from the backup information being implemented on the backup agent module 30, then transmit them to the backup master module 10.

Also, the backup agent module 30 is configured to receive backup or recovery commands from the backup manager module 20 in order to implement a backup or recovery according to the commands. When it receives a command for implementing a backup on a backup object disk 60, a volume of data within the backup object disk 60 is divided and read into the unit data, the n-threads are generated, and the unit data that has been read from the backup object disk 60 is compressed sequentially to be stored to the backup disk 70.

Besides, the backup agent module 30 implements the functions of collecting and managing backup information for each volume while implementing the backup, and reporting the status of backup implementation in progress to the backup manager module 20.

For reference, regarding the thread, that is a kind of module for which various jobs are divided into small ones as a separate job unit within a process, a program can be internally divided into the unit of threads for implementing simultaneously.

In this manner, the system of high-speed and bulk backup according to the invention can reduce the time required for backup, increase the compression rate substantially, and store a lot more data under the same backup disk circumstance, using the feature that the data within a backup object disk 60 can be divided and read into the unit data, along with the feature that the data read can be compressed simultaneously by a plurality of threads to be stored onto a backup disk 70.

FIG. 4 is a block diagram showing another preferred embodiment of the invention, comprising a backup manager server 300 and a backup master server 20 for sending backup commands to the backup manager server 300, wherein the backup manager server 300 includes a backup manager module 20, a backup agent module 30, a backup object disk 60 and a backup disk 70, and the backup master server 200 includes a backup master module 10, compared with the components shown in FIG. 3.

Here, it can be connected via an interface or a network between the backup master server 200 and the backup manager server 300, and it can have a tree type configuration wherein a plurality of backup manager servers 300 are managed by a backup master server 200.

The configuration and its implementation shown in FIG. 4 are not so different from the configuration and its implementation shown in FIG. 3. When connected via an open network like the Internet, a plurality of backup manager servers 300, corresponding to the clients against a backup master server 200 in its concept, are managed by a backup master server 200 through the backup operating command received according to a reserved backup information. At the side of backup manager server 300, the backup command received at the backup manager module 20 will be transmitted to the backup agent module 30, and moreover the backup agent module 30 can be configured that a volume of data from the backup object disk 60 is divided and read into a predetermined size of unit data, then a plurality of threads are generated and the divided unit data is compressed sequentially to be stored into the backup disk 70.

According to the embodiment shown in FIG. 4, in this maimer, it can reduce the time required for backup, increase the compression rate substantially, and store more data under the same backup disk circumstance, using the feature that the data within a backup object disk 60 can be divided and read into the unit data, along with the feature that the data read can be compressed simultaneously by a plurality of threads to be stored into a backup disk 70, and moreover, the clients connected via an open network such as the Internet, i.e. temporary backup manager servers 300, can be managed and administered in a bundled group unit.

FIG. 5 is a block diagram showing still another preferred embodiment of the invention. Here, a backup master server 200, a backup manager server 300 and a backup agent server 400 are configured respectively as a separate server, and these individual servers are connected via an interface or a network for implementing a backup. Moreover, a plurality of backup manager servers 300 can be connected to a backup master server 200, and also each backup manager server 300 can be connected with each backup agent server 400.

This time, a backup object disk 60 on which the data is stored will be configured with each backup manager server 300, however a backup disk 70 on which the compressed data of backup object disk 60 is stored will be configured with each backup agent server 400.

As shown in FIG. 5, a command including backup operating commands is received at a backup master server 200 and transmitted to a backup manager server 300, then the backup reservation information for each volume can be managed at a backup manager module 20 within the backup manager server 300, and a volume of data can be divided and read into a predetermined size of unit data on the backup object disk, then transmitted to a backup agent server 400.

At the side of backup agent server 400, a plurality of threads are generated according to the backup command received from the backup manager server 300, then the unit data supplied from the backup manager server 300 can be sequentially received and compressed by a plurality of threads to be stored on a backup disk.

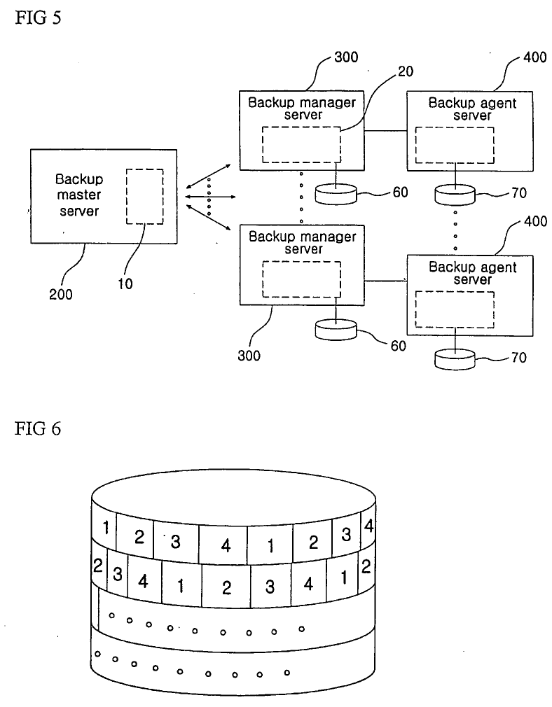

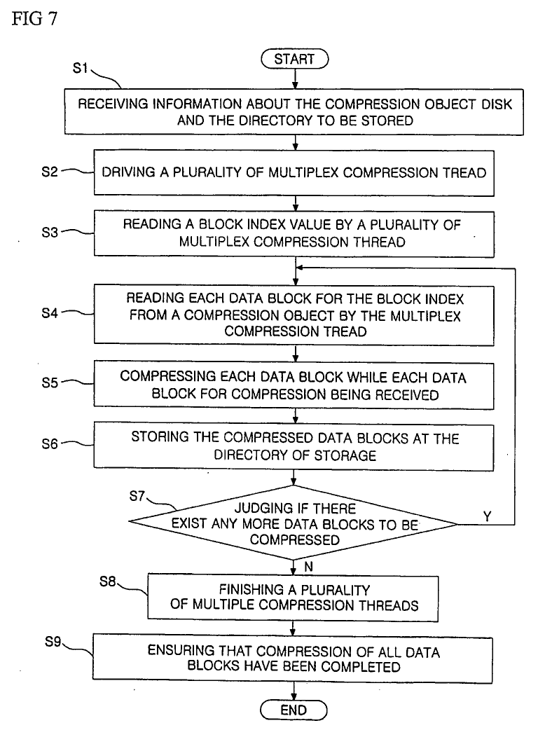

As illustrated in FIG. 6, a volume data within a backup object disk 60 can be divided into a plurality of unit data by a backup agent module 30 or a backup agent server 400. In case the number of threads are four in a volume, the index will be sequentially assigned as 1, 2, 3, 4, 1, 2, 3, 4, 1, 2, . . . , etc., and the data belong to the corresponding index will be read by each thread for implementing the compression process. An experimental result shows that the most suitable size for the unit data divided would be “block size (4096×N)×number of blocks (M)≅20˜25 Mbytes” for implementing a backup at high-speed.

As illustrated in FIG. 7, a flowchart showing a method of high-speed and bulk backup, a backup command from a backup manager module 20 or a backup manager server 300 can be supplied to a backup agent module 30 or a backup agent server 400 for implementing a backup.

According to FIG. 7, a backup agent module 30 or a backup agent server 400 receives information about the compression object disk and the directory to be stored from a backup manager module 20 or a backup manager server 300 (step S1).

Then, a plurality of multiplex compression threads will be driven by the backup agent module 30 or the backup agent server 400, at this time the input will be a block index value (step S2), and this value received at the step S2 will be divided and read by a plurality of compression threads (step S3).

Subsequently each data block for the block index will be read from a compression object disk by the multiplex compression threads (step S4), and then it will be compressed while each data block for compression being received (step S5).

The compressed data blocks produced by the step S5 will be stored at the directory of storage (step S6), then judging if there exist any more data blocks to be compressed, when there exist, it will be interrupted to the step S3 where another data block can be read after the step S10 where the block index is increased (step S7).

When there exist no more data blocks to be compressed according to the result of judgment at the step S7, a plurality of multiple compression threads will be finished (step S8), then the same backup procedure will be completed by ensuring that compression of all data blocks have been completed.

Here, it is also possible to confirm whether the bulk backup is completed correctly or not. As a detailed method, when the procedure of backup and recovery has been completed, it will be checked again whether the backup has been completed in the proper way, e.g. the data on a backup object disk will be backed up to a backup disk and restored to the backup object disk again, and then the correctness of restored data will be checked by comparing the data content of the backup object disk with that of the backup disk, consequently this type of verification can be used for a method to secure the stability of backup.

Though the preferred embodiments according to the present invention are described aforementioned in detail, it will be apparent to those skilled in the art that various modifications and variations can be made in the present invention within the scope of the appended claims and their equivalents.

### Industrial Applicability

According to the present invention, it has an effect that the time required for backup and recovery can be reduced substantially as well as the size of data after implementing a backup can be reduced drastically, therefore excellent backup performance can be secured for users and also the TCO (Total Cost for Ownership) for backup resources can be reduced substantially.

Besides, it can provide safe protection for users under E-business environment requiring an enormous amount of data, and furthermore the performance of high-speed and bulk backup as well as the function of powerful data compression, which had not been available in the existing backup management solutions, can be used effectively for the task of high-speed and bulk backup in the areas of ASP/ISP, communications, banking, on-line services, and business enterprises.

1. A system of high-speed and bulk backup comprising:
a backup object disk whereon a backup object data to be stored;
a backup disk whereon the backup object data to be compressed and stored;
an input/output unit, wherein the command including backup operating commands is input and the results from the predetermined command is output;
a backup means, wherein a volume of data on said backup object disk is divided into a predetermined size of unit data, a plurality of threads rimming several flows within a process are generated and thereby said divided that data is sequentially compressed and stored onto said backup disk; and
a central processing unit, wherein the backup operating command supplied through said input/output unit is processed for implementing a backup using said backup means.

2. The system of high-speed and bulk backup of claim 1 comprising:
a backup master module, wherein the backup operating command supplied through said input/output unit and central processing unit is received and transmitted to a backup manager module;
a backup manager module, wherein a backup operating command required for implementing a backup is received from said backup master module and thereby the backup reservation information for each volume is managed, a backup status and backup history information for each volume is collected and managed, and the backup command for a disk volume according to a backup schedule is generated; and
a backup agent module, wherein a backup command is supplied from said backup manager module and thereby the volume of data on said backup object disk is divided into a predetermined size of unit data, a plurality of threads running several flows within a process are generated and thereby said divided unit data is sequentially compressed and stored onto said backup disk.

3. The system of high-speed and bulk backup of claim 1, wherein said unit data is divided with 20˜25 Mbytes when the block size for division is multiplied by the number of blocks.

4. The system of high-speed and bulk backup of claim 1,
wherein said backup means implements a volume backup by dividing the whole volume of said backup object data through accessing to a raw device regardless of the type of file, and then by compressing into a plurality of threads, in case a backup object data stored in said backup object disk has more than one hundred thousand files.

5. The system of high-speed and bulk backup of claim 1,
wherein said backup means implements a file backup by dividing said backup object data into the unit of file, and then by compressing into a plurality of threads, in case a backup object data stored in said backup object disk has less than one hundred thousand files.

6. A system of high-speed and bulk backup comprising:
a backup master server including a backup master module receiving a backup operating command; and
a backup manager server including a backup object disk whereon the backup object data is stored, a backup disk whereon the backup object data is compressed and stored, a backup manager module wherein the backup operating command required for backup operation is received from said backup master server and thereby the backup command for a volume of disk is generated according to a backup schedule, and a backup agent module wherein according to the backup commands supplied from said backup manager module, the volume of data on said backup object disk is divided into a predetermined size of unit data, a plurality of threads running several flows within a process are generated, and thereby said divided unit data is sequentially compressed and stored onto said backup disk.

7. The system of high-speed and bulk backup of claim 6, wherein said predetermined size of unit data is divided with 20˜25 Mbytes when the block size is multiplied by the number of blocks.

8. The system of high-speed and bulk backup of claim 6,
wherein said backup manager server implements a volume backup by dividing the whole volume of said backup object data through accessing to a raw device regardless of the type of file, and then by compressing into a plurality of threads, in case a backup object data stored in said backup object disk has more than one hundred thousand files.

9. The system of High-speed and bulk backup of claim 6,
wherein said backup manager server implements a file backup by dividing said backup object data into the unit of file, and then by compressing into a plurality of threads, in case a backup object data stored in said backup object disk has less than one hundred thousand files.

10. A system of high-speed and bulk backup comprising:
a backup master server including a backup master module receiving a backup operating command;
a plurality of backup manager servers including a backup object disk whereon the backup object data is stored, and a backup manager module wherein the backup operating command required for backup operation is received from said backup master server and thereby the backup command for a volume of disk is generated according to a backup schedule, and
a plurality of backup agent servers including a backup disk whereon the backup object data is compressed and stored, and a backup agent module wherein according to the backup command supplied from said backup manager module, the volume of data on said backup object disk is divided into a predetermined size of unit data, a plurality of threads rimming several flows within a process are generated, and thereby said divided unit data is sequentially compressed and stored onto said backup disk.

11. The system of high-speed and bulk backup of claim 10, wherein said predetermined size of unit data is divided with 20˜25 Mbytes when the block size is multiplied by the number of blocks.

12. The system of high-speed and bulk backup of claim 10,
wherein said backup agent server implements a volume backup by dividing the whole volume of said backup object data through accessing to a raw device regardless of the type of file, and then by compressing into a plurality of threads, in case a backup object data stored in said backup object disk has more than one hundred thousand files.

13. The system of high-speed and bulk backup of claim 10,
wherein said backup agent server implements a file backup by dividing said backup object data into the unit of file, and then by compressing into a plurality of threads, in case a backup object data stored in said backup object disk has less than one hundred thousand files.

14. A method of high-speed and bulk backup comprising the steps of:
receiving the compression object disk information and the directory information to be stored;
driving a plurality of compression threads;
dividing and reading block index values supplied from said compression object disk on a plurality of driven compression threads;
reading each data block belong to the block index read for each compression thread;
compressing simultaneously for said each data block read on a plurality of said compression threads;
storing the data blocks compressed to a storage directory for a plurality of compression threads;
judging whether there exist more data blocks to be compressed, increasing the block index if there exist more data blocks to be compressed, then interrupting to read said data block;
finishing a plurality of threads if there exist no data blocks to be compressed; and
completing a backup by ensuring that compression of all data blocks is completed.
